(19) United States
(12) Patent Application Publication
(10) Pub. No.: US 2003/0215308 A1
(43) Pub. Date: Nov. 20, 2003

(54) Shaping part for producing books with rounded spine

(76) Inventor: Horst Rathert, Minden (DE)

Correspondence Address: McGLEW AND TUTTLE, P.C., SCARBOROUGH STATION, SCARBOROUGH, NY, 10510-0827, US

(21) Appl. No.: 10/407,980

(22) Filed: Apr. 4, 2003

(30) Foreign Application Priority Data
Apr. 5, 2002 (DE) DE 102 15 110.5

(51) Int. Cl. B42C 5/02

(52) U.S. Cl. 412/30

(57) ABSTRACT

A shaping part for producing books with round spine includes a frame (3, 5, 7, 10), which defines an essentially rectangular inner space, and in the inner space of which a plurality of vertically adjustable lamellae, whose orientation at right angles to the plane of the frame is predetermined by the frame, are arranged next to one another. Any desired profile surface, preferably in the form of a radius, can be formed by a suitable displacement of lamellae located next to one another. To absorb strong normal forces during pressing, the lamellae are braced against one another. The lamellae can be heated by contact with the heated carrier body for preforming the spine of books. The profile surface of the shaping part may be concave or convex.

### FIELD OF THE INVENTION

The present invention pertains to a shaping part for producing books with a rounded spine.

### BACKGROUND OF THE INVENTION

In producing books with rounded spine, the shaping process takes place in consecutive operations, the so-called pressing of the rounded spine, the preforming of the screenings area of the cover, and the postforming of the rounded book for the subsequent folding, with replaceable shaped parts graduated according to the thickness of the book and the curvature of the rounding to be prepared.

The pressing of the size film on the spine of the book is achieved and a fold is formed on the inner book on the sides during the pressing after the rounding by the action of a normal force on the spine surface of the book by a shaping part adapted to the radius of curvature of the spine of the book and by a simultaneous tangential movement toward the spine of the book. The rounding of the spine of the book which was generated before is stabilized as a result.

A part symmetrical to the center of the inner book with a concave contact surface with the inner book is usually used as the shaping part. The radius is somewhat greater than the radius of curvature on the spine of the inner book. The shaping part performs pivoting movements to the left and right in the direction of the front side and the rear side of the book.

Solutions are also known in which two shaped parts perform an oppositely directed pivoting movement of equal amount centrally to the inner book. These shaped parts are of a mirror-symmetrical shape in relation to one another.

To obtain a defined shape of the spine, the shaped parts must be coordinated with the dimension of the spine of the book in terms of width and radius, so that there are a plurality of shaped parts which must be replaced in case of a change from one format to another.

The screenings area of the book cover is prerounded by a shaping part and temperature effect and adapted to the radius on the spine of the book. If the radius is selected to be too large, the screenings area pulls back the rounding of the inner book. If, by contrast, it is selected to be too small, a gap is left between the spine of the cover and the spine of the inner book on the finished book.

Again, accurate adaptation to the spine of the inner book and the curvature of the rounding must be performed in this case as well, which again means likewise a plurality of different shaped parts in practice, which must be replaced in case of a change from one format to another.

Finally, the inner book must be postformed before the folding and full pressing. The inner book is pressed into the rounding of the cover screenings area by a web, which acts on the front section. The spine of the inner book must now be supported in its shape if a really radius-like spine is to be obtained. The shaped parts now have a one-part design symmetrical to the spine of the inner book with a concave contact surface. The radius of the shaped parts corresponds now to the desired radius of the spine of the inner book. A plurality of shaped parts is again needed in this case as well.

To avoid this, solutions are known in which the spine of the inner book is not pressed against a radius-like shaping part, but it lies only on the sides by means of strips, which lie tangentially on the spine of the inner book on the outside. No radius-like shaping takes place here by the force of the form web in the middle of the inner book on the front section and the support action on the outside on the spine, but a parabola-like shape is rather formed, which generates the impression of a pointed spine.

The need for many shaped parts, as was described above for the relevant operations in producing books, means a high tooling expense. This is of increasing significance in light of decreasing numbers of copies printed and consequently more frequent changes from one format to another.

Despite many existing format change parts, a shaping part is always optimal for one rounding radius and one inner book thickness only. The format part always represents only a compromise for deviating book sizes.

An additional drawback is frequently that the correct shaping part cannot be used straight off, because the behavior of the paper during rounding and pressing, during the preforming of the cover and the postforming of the book is often undefined. It is therefore necessary to make another change.

### SUMMARY OF THE INVENTION

The basic object of the present invention is to make it possible to continuously optimize shaped parts to the desired radius of the spine of the inner book and consequently to considerably reduce the effort needed for format change.

According to the invention a shaping part for producing books with a rounded spine is provided with a frame defining an essentially rectangular inner space. A plurality of vertically adjustable lamellae, each with an orientation at right angles to the plane of the frame that is predetermined by the frame, are arranged next to one another in the inner space. Any desired profile surface, preferably in the form of a radius, can be formed by means of the lamellae by a suitable displacement of lamellae located next to one another.

Essential features of the present invention are that the shaping part has a frame defining essentially an inner space of a rectangular design and that a plurality of vertically displaceable lamellae, which are oriented at right angles to the plane of the frame predetermined by the frame, are arranged next to one another in the inner space. This allows for the formation of any desired profile surface by means of the lamellae.

In their total thickness as a set of lamellae, the lamella plates arranged next to one another cover the thickness range of the book to be formed.

The individual lamellae are displaceable in relation to one another in the normal direction when viewed toward the plane of the spine of the inner book. Displaceability over the height of the inner book corresponding to the length of the lamellae is ruled out by the circular frame.

It is advantageous, among other things, for the lamellae to be provided over their length with at least two curved elongated holes, through which pass guide pins.

When the shaping part is adjusted to another radius, the guide pins are adjusted in the longitudinal direction of the elongated holes in the lamellae, and they perform as a result a relative movement in relation to the lamella plates along the curved elongated holes and now displace the lamella plates according to the shape of the curved elongated holes at right angles to the spine surface of the inner book to be formed. Each lamella is provided with an individual curve. Thus, a different movement is obtained in the Y direction, which leads to the shaping of the necessary radius, due to a movement of the pins within a three-dimensional system of coordinates X-Y-Z in the X direction, depending on the position of the lamella along the Z axis.

The radius changes with the movement of the guide pins in the X direction, doing so preferably proportionally, so that there is a linear association for an automatic adjustment.

However, the path of adjustment in the X direction may also be used several times. Part of the adjustment path may be used, e.g., to generate a modified radius, which terminates tangentially at the edge, when, e.g., a strong fold is to be generated at the longitudinal edges of the spine with a strong pivoting movement of the shaping part.

A concave surface of the shaping part can be generated, as is needed for pressing the spine of the inner book and for postforming the inner book. However, a convex surface, which is necessary for the preforming of the cover, can be generated as well.

The radius is always associated with an inner book thickness, and the ratio of the inner book thickness to the radius may vary within limits depending on how marked the rounding is.

Only the inner part of the shaping part is used in the case of a small radius. The unused part may be set, e.g., simply in parallel to the spine of the inner book.

The shaped parts normally have a one-part design.

It may be advantageous for the purpose of pressing the spine of the inner book to use divided shaped parts, which press antisymmetrically simultaneously toward both sides of the spine of the inner book by a pivoting movement.

These shaped parts may also be designed according to the present invention. Both parts of the shaping part have separate elements for performing the movement in the X direction and separate guide pins in the curved elongated holes.

The movement in the X direction may be performed by the outer limiting plates or by a middle plate. The adjustment by moving a middle plate is possible when the position of the middle lamella always remains the same regardless of the radius set.

The lamella plates are normally guided between the outer limiting plates without clearance. Good contact between the lamella plates is important for use during the preforming of the cover, where the entire form block is heated to as high as 200° C.

During the pressing of the spine, where strong normal forces must be applied to the spine of the inner book, the lamella plates are preferably clamped to each other, e.g., by means of hydraulic cylinders at the outer limiting plates, which press together the set of lamellae. The guide pins, which pass through the lamellae in the curved elongated holes, act now as a pulling connection between the outer limiting plates. The shaping part acts like a massive part due to the clamping.

The hydraulic pressing device is released for the adjustment.

Support plates may be accommodated distributed between the lamellae. They are in contact on the rear side with a support plate and transmit the normal force, which is absorbed only by the limiting plates without these support plates. For the passage of the guide pins, the support plates have elongated holes, which extend in parallel to the support plate and make possible the free adjustment in the X direction.

The lamella plates may be rounded, beveled or angular at the site of contact with the inner book, depending on the particular application.

A beveling approximately following the curvature of the rounding is preferred for the preforming of the cover in order to obtain the best possible thermal contact with the screenings material.

Rounding of the plate edges is important for the postforming of the book to avoid markings by sharp edges.

Depending on the pressing process, either rounding or sharp plate edges are to be recommended for the pressing application.

If a strong tangential movement of the shaping part is generated on the spine of the inner book during the pressing process, rounded plate edges are advantageous. The round edges are not caught during the sliding over, but they generate a fulling effect beneficial for the pressing.

In other pressing processes, in which accurate coordination of the tangential movement, the normal movement and the pivoting movement of the shaping part takes place, sharp edges of the lamella plates are advantageous, because they make possible the stretching of the spine due to the positive-locking connection with the spine and thus make possible a dimensionally stable rounding.

Various embodiments of the shaped parts according to the present invention will be described below on the basis of the drawings attached. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a perspective view showing a shaping part with convex shape with a radius Rₘₐₓ;

FIG. 2 is a sectional view showing a shaping part with convex shape set in the section to a small radius R;

FIG. 3 is a sectional view showing a one-part shaping part of concave shape;

FIG. 4 is a perspective view of a two-part shaping part of concave shape;

FIG. 5 is a side view showing a lamella made of plate with a control cam designed as a curved elongated hole;

FIG. 6 is an end view showing a one-part shaping part of concave shape with rounded lamella edges;

FIG. 7 is an end view showing a two-part shaping part with sharp angular edges of the lamellae; and

FIG. 8 is a sectional view showing a two-part shaping part with hydraulic clamping of the lamella packages.

### DESCRIPTION OF THE PREFERRED EMBODIMENTS

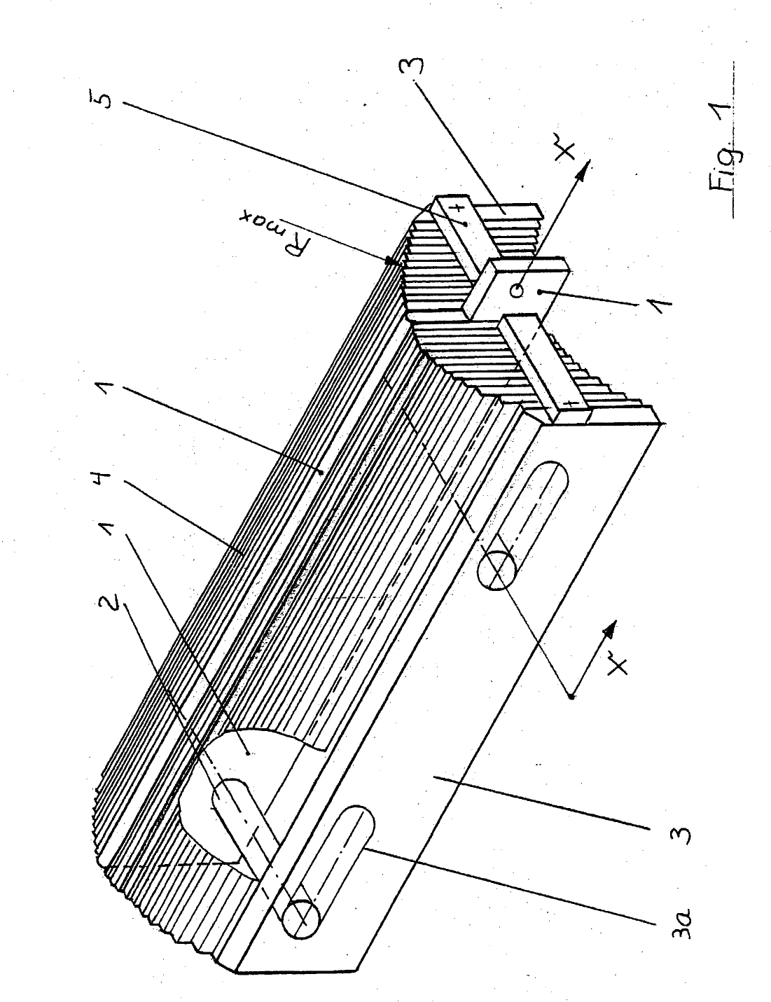

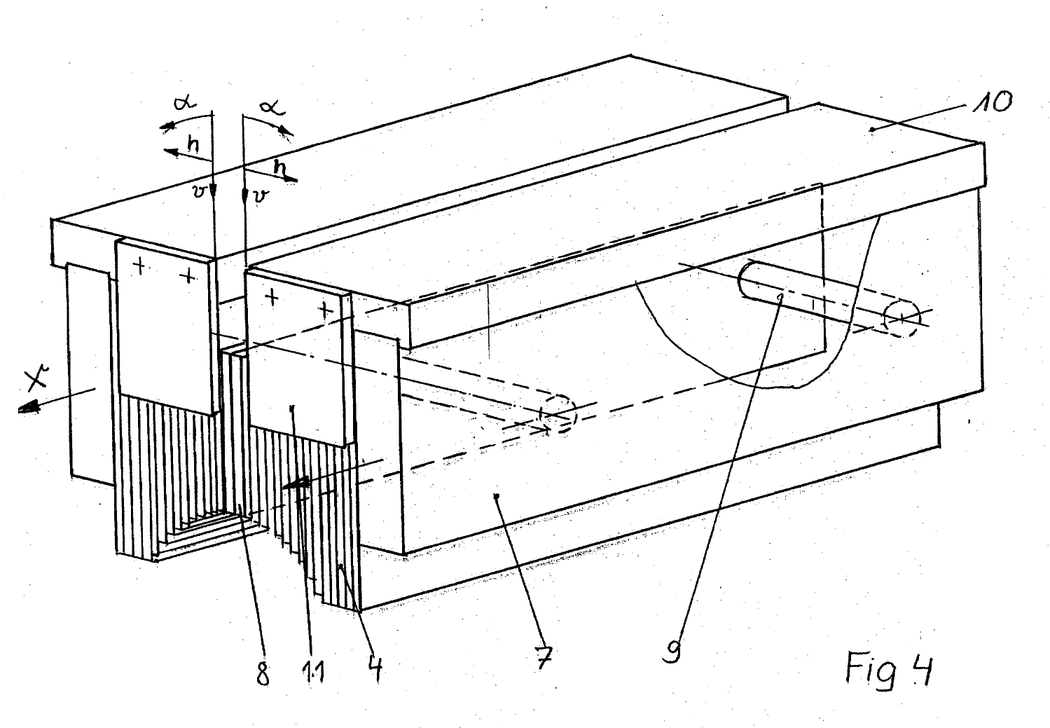

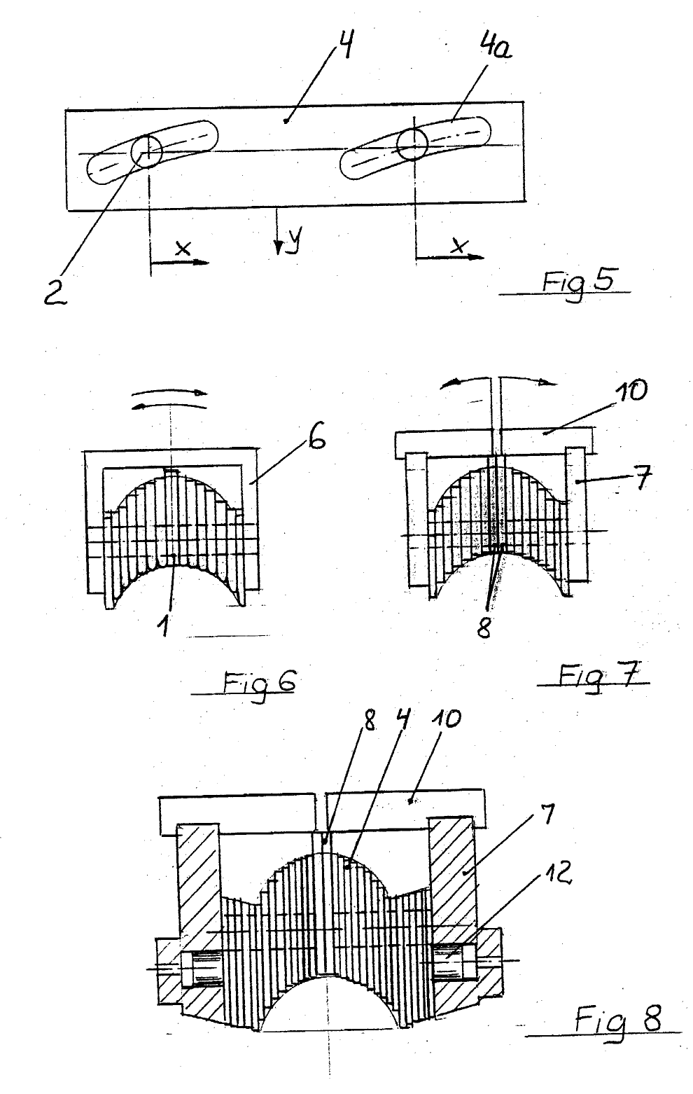

Referring to the drawings in particular, FIG. 1 shows a perspective view of a shaping part with convex contour, as is needed for preforming the cover. A slide 1, which can be displaced in the longitudinal direction by the amount x, is located in the middle. The guide pins 2, which are guided in the outer side parts 3 with elongated holes 3a, are fastened to the slide 1 on both sides. Together with stops 5, the side parts 3 form a frame, within the interior space of which a plurality of lamellae 4 are arranged located next to one another. The guide pins 2 pass through the lamellae 4 on the left and right of the slide 1 in control cams 4a, which are formed by curved elongated holes and generate an adjustment in the Y direction during the longitudinal movement of the pins 2 in the X direction, as is apparent from FIG. 5. Depending on its distance from the middle of the shaping part, each lamella 4 has a different control cam 4a formed by a curved elongated hole each, so that the contour of the shaping part is changed correspondingly by the movement in the X direction.

The side parts 3 remain stationary during the displacement of the slide 2 and hinder the displacement of the lamellae 4 in the direction X by means of the stops 5. FIG. 2 shows how the contour has changed after an adjustment of the shaping part corresponding to FIG. 1.

The contact area with the spine of the book preferably has a radius. However, another contour is also conceivable.

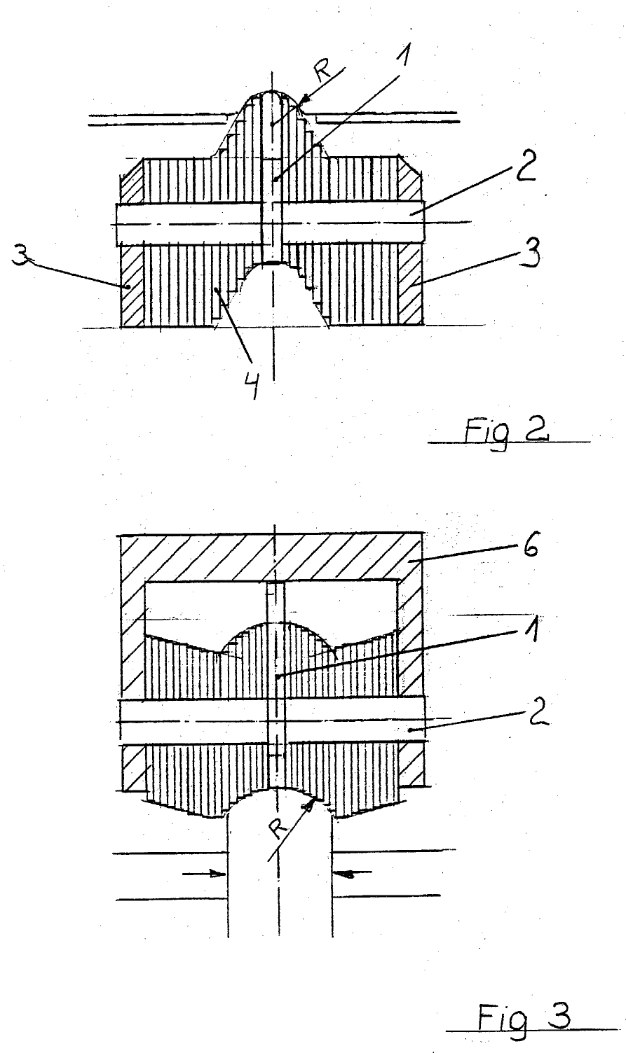

FIG. 3 shows a shaping part with concave contour for the pressing of the spine of the inner book or for the postforming of the spine of the inner book. The pins 2 are again fastened to the slide 1. The pins again slide in elongated holes of the frame 6 during the adjustment of the slide in the X direction and again pass through the lamella 4 in control cams 4a, as a result of which adjustment of the individual lamella takes place in the Y direction.

A two-part shaping part is used in some solutions that have become known for the pressing of the spine of the inner book instead of a one-part shaping part, which performs a reciprocating pivoting movement on the spine of the inner book. Such a solution is shown in FIG. 4.

The lamellae 4 are located between the side parts 7 and the counterplates 8 and guide pins 9, which fix the position of the counterplates 8 and side parts 7, pass through them. The side parts 7 can be displaced in the stationary guide plate 10 according to the adjustment X. The lamellae are now retained by the stops 11 and are displaced in the lamellae 4 in the Y direction via the control cams 4a. Both halves of the shaping part perform an opposite pivoting movement a and a horizontal movement h as well as a vertical movement v for the pressing operation.

A radius-like contour is preferably generated in the contact area with the spine of the book. The outer, unused area of the shaping part is set flat so that it does not interfere during the pivoting.

The edges of the lamella plates are preferably made sharp-edged angular in this type of pressing. This results in good carrying on the spine of the inner book and greater stretching of the spine and consequently a better result of pressing can be obtained (see FIG. 7).

In case of pressing with a one-part shaping part, which is pivoted to and fro, e.g., twice on the spine of the book, the edges of the lamellae are preferably rounded. The round edges then generate a fulling movement on the spine of the inner book, which stretches the spine very well (see FIG. 6).

During use for preforming the cover, the lamella edges are preferably rounded in order to obtain a better thermal contact.

Strong forces occur on the lamellae during the pressing of the spine of the inner book. It is therefore useful to clamp the lamellae 4 against each other.

The hydraulically actuated pistons 12 shown in FIG. 8, which apply a normal force on the lamellae 4, can be used for this. The lamellae are fixed against each other by friction and do not load the pins 2 with the pressing force.

In the case of the two-part shaping part, the lamellae are clamped against the inner counterplates 8. The clamping needs to act from one side only in case of the one-part shaping part. The lamellae are clamped now against the frame 6.

The hydraulic clamping is released during the adjustment of the contour.

The counterplates 8 and the slide 1 are supported against the side parts 7 in order to absorb the pressing forces directly.

If the shaped parts need an increased temperature, e.g., during the preforming of the cover, the heat is introduced via the side parts 3, which are provided with a heater.

It may be of interest for certain applications, e.g., for the preforming of the cover, to divide the range of adjustment X into sections, which generate different types of the contour. For example, it would be possible to use one part of the path of adjustment for generating a more or less large radius, while the other part is used to generate a rectangular contour of different widths for books with straight spines.

While specific embodiments of the invention have been shown and described in detail to illustrate the application of the principles of the invention, it will be understood that the invention may be embodied otherwise without departing from such principles.

What is claimed is:

1. A shaping part for producing books with rounded spine, the part comprising:
a frame defining an essentially rectangular inner space;
a plurality of lamellae, the frame for receiving and orienting the plurality of vertically adjustable lamellae with the orientation at right angles to the plane of the frame and being predetermined by the frame with the lamellae arranged next to one another in the inner space, wherein any desired profile surface, preferably in the form of a radius, can be formed by means of the lamellae by a suitable displacement of lamellae located next to one another.

2. A shaping part in accordance with claim 1, further comprising guide pins passing through the lamellae and disposed in control cams provided in the form of curved elongated holes, wherein a displacement of the lamellae in a profile formation direction at right angles to the plane of the frame is generated by a longitudinal movement of the lamellae in the plane of the frame.

3. A shaping part in accordance with claim 1, wherein a path of adjustment of the lamellae in a direction of the longitudinal movement is proportionally associated with a radius of the rounding on the shaping part.

4. A shaping part in accordance with claim 3, wherein the path of adjustment is divided into sections for the different shaping of the profile.

5. A shaping part in accordance with claim 1, wherein the profile surface may be convex or concave.

6. A shaping part in accordance with claim 1, wherein the shaping part has a two-part frame with two counterplates arranged in parallel to one another in the vertex of the profile surface.

7. A shaping part in accordance with claim 1, further comprising a bracing device wherein the lamellae are arranged within the frame and can be braced against one another preferably hydraulically, and the bracing is released during the adjustment.

8. A shaping part in accordance with claim 1, wherein the edges of the lamellae facing the profile surface are rounded.

9. A shaping part in accordance with claim 1, wherein the edges of the lamellae facing the profile surface are sharp-edged and angular.

10. A shaping part in accordance with claim 1, wherein a heater is provided for heating the lamellae.

11. A process for producing books with rounded spine, the process comprising:
providing a frame defining an essentially rectangular inner space;
positioning a plurality of lamellae in the frame and orienting the plurality of vertically adjustable lamellae with the orientation at right angles to the plane of the frame with the lamellae arranged next to one another in the inner space; and
forming a desired profile surface by displacement of lamellae located next to one another.

12. A process in accordance with claim 11, further comprising providing guide pins passing through the lamellae and disposed in control cams provided in the form of curved elongated holes, and displacing the lamellae in a profile formation direction at right angles to the plane of the frame by a longitudinal movement of the lamellae in the plane of the frame.

13. A process in accordance with claim 11, wherein a path of adjustment of the lamellae in a direction of the longitudinal movement is proportionally associated with a radius of the rounding on the shaping part, wherein the path of adjustment is divided into sections for the different shaping of the profile, wherein the profile surface may be convex or concave.

14. A process in accordance with claim 11, wherein the shaping part has a two-part frame with two counterplates arranged in parallel to one another in the vertex of the profile surface.

15. A process in accordance with claim 11, further comprising a bracing device wherein the lamellae are arranged within the frame and can be braced against one another preferably hydraulically, and the bracing is released during the adjustment.

16. A process in accordance with claim 11, wherein the edges of the lamellae facing the profile surface are one of rounded sharp-edged and angular sharp-edged.

17. A process in accordance with claim 11, wherein the lamellae are heated.

18. A shaping part for producing books with a curved spine, the shaping part comprising:
a frame defining an essentially rectangular inner space;
a plurality of vertically adjustable lamellae, the lamellae being arranged next to one another, each with an orientation predetermined by the frame and at right angles to a plane of the frame, the vertical adjustment of the lamellae presenting any desired profile surface with the displacement of lamellae located next to one another.

19. A shaping part according to claim 18, further comprising:
a bracing device to brace the lamellae against one another to absorb strong normal forces during pressing.

20. A shaping part according to claim 18, further comprising guide pins passing through the lamellae and disposed in control cams provided in the form of curved elongated holes, wherein a displacement of the lamellae in a profile formation direction at right angles to the plane of the frame is generated by a longitudinal movement of the lamellae in the plane of the frame.
